(19) United States
(12) Patent Application Publication
(10) Pub. No.: US 2003/0234070 A1
(43) Pub. Date: Dec. 25, 2003

(54) EXPANDABLE AND COLLAPSIBLE WINDOW COVERING AND METHODS FOR MAKING SAME

(76) Inventors: JOHN D. RUPEL, VERONA, WI (US); DARRELL J. KUTCHMAREK, WAUNAKEE, WI (US); THOMAS W. TOLBERT, FORT MILL, SC (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 08/622,070

(22) Filed: Mar. 26, 1996

(51) Int. Cl. B32B 3/00; B65B 11/00

(52) U.S. Cl. 156/70

(57) ABSTRACT

A method for producing an expandable and collapsible product for use in a window covering includes the steps of pleating a continuous length of material, bonding together opposing faces that face one side of the product to form a series of enclosed cells, bonding together opposed faces facing the other side of the product to form another series of enclosed cells, and removing creases from one side of the product to open one of the series of enclosed cells so that the other series of enclosed cells remains intact and connected to one another. The creases may be removed by abrading the material along the creases. The opposed faces may be bonded by applying a bead of adhesive to one of the faces and compressing the faces together. Also provided is a window covering having a multi-cellular expandable and collapsible body. The body has a number of strips of material that are creased in the center parallel to the long edges. The long edges are joined together to form a tab. Each of the strips of material define an elongated cell bounded by the creased fold on one side and the tab on the other. Successive cells are joined together by a bond line intermediate the creased folds and the tabs. A headrail is connected to the top of the body, and a bottom rail is connected to the bottom of the body. The body is provided with a means for raising and lowering the bottom rail with respect to the headrail.

### FIELD OF THE INVENTION

The present invention relates to expandable and collapsible window coverings and, more particularly, to expandable and collapsible window coverings having a cellular construction. In addition, the present invention relates to methods for making such window coverings.

### BACKGROUND OF THE INVENTION

Expandable and collapsible cellular window coverings have enjoyed considerable success as a result of their pleasing aesthetic appearance and their insulating qualities. Conventionally, two types of these window coverings have been available. One type includes a plurality of elongated cells aligned one on top of the other in a single row. In one method for making a window covering of this “single cell” type, disclosed in U.S. Pat. No. 4,603,072 to Colson, a plurality of individual strips are folded into a tubular configuration and adhered together, one on top of the other, to form longitudinally extending cells. In another method, disclosed in U.S. Pat. No. 4,288,485 to Suominen, a plurality of strips of material are stacked and adhered together along spaced bands to form a curtain having a plurality of cells in a honeycomb arrangement. The curtain may be cut between the bands to provide a single row of cells aligned on top of one another. Yet another method for forming window coverings of this type is disclosed in U.S. Pat. No. 5,205,891 to Neff, in which the opposed pleats in two pleated sheets are joined together to form a single row of aligned cells. The foregoing methods suffer from significant drawbacks which primarily relate to the need to align and adhere together multiple strips of material, the need to align and adhere together multiple sheets of material, or the need to accurately align the pleats in one sheet with those in another.

Another type of expandable and collapsible window covering includes a plurality of elongated cells arranged in at least two rows of partially overlapping cells. Methods for forming this “double cell” type of window covering, such as disclosed in U.S. Pat. No. 5,160,563 to Kutchmarek et al. and U.S. Pat. No. 5,106,444 to Corey et al., generally involve folding a continuous sheet of material upon itself in alternating fashion and adhering adjacent folds together. These methods utilize significantly greater amounts of material than the methods for forming a single row of aligned cells, and therefore have a greater material cost for each square foot of window covering.

There therefore exists the need for an improved method for forming expandable and contractible window coverings having a single row of aligned cells which will overcome the problems associated with handling and aligning multiple sheets or strips of material, yet which will not use the lengths of material associated with the formation of “double cell” window coverings from a single continuous sheet of material.

### SUMMARY OF THE INVENTION

The present invention addresses these needs.

One aspect of the present invention provides methods of making an expandable and collapsible, single-cell product for window coverings or the like from a single web of foldable material. In accordance with one method, a continuous length of material is pleated to form a plurality of first creases projecting toward a first side of the material and a plurality of second creases projecting toward a second side of the material. The first and second creases are interconnected by panels having a first face facing generally toward the first side and a second face facing generally toward the second side. opposing second faces are then bonded along first bond lines at a spaced distance from the first creases in order to form a series of enclosed cells bounded by the first creases and the first bond lines. Opposing first faces are then bonded along second bond lines between the first creases and the first bond lines in order to form a second series of enclosed cells bounded by the second creases and the second bond lines.

The first creases are then removed from the material, opening the first series of enclosed cells. The first creases may be removed by abrading, and more specifically by first abrading with a coarse media, and then abrading with a fine media. The second series of enclosed cells remains connected by the first bond lines.

The bond lines may be applied so that the distance between the first creases and the second bond lines is less than the distance between the second creases and the first bond lines. Preferably, the first bond lines are about equidistant between the second creases and the second bond lines. The first bond lines may include at least two parallel connecting lines separated by a predetermined distance.

In accordance with another method, an expandable and collapsible product is produced by starting with a web of accordion folded material having a series of panels united in alternate succession along creased folds. The panels are unfolded, and adhesive is applied to an alternating side of each panel in a band parallel to and spaced from the preceding creased fold. The panels having adhesive applied thereto are then refolded along the creased folds, the band of adhesive being applied to adjacent panels joined by the creased fold. The creased folds on one side of the product are then removed, forming a plurality of aligned cells bounded by the other creased folds and bands of adhesive on one side of the panels. The plurality of aligned cells are connected to one another by bands of adhesive on the other side of the panels.

In yet another method, an expandable and collapsible product is produced by folding a web of material widthwise alternately in opposite directions along creased folds disposed at first and second sides of the web. This forms a series of normally flat panels of uniform width that are united in alternate succession along respective folds. The panels are then unfolded, and adhesive is applied on the second side of the web to one of each pairs of panels that are united along a creased fold. The adhesive is applied in a band parallel to and spaced from the creased fold. Adhesive is also applied to the first side of the web to one of each pair of panels that are united along a creased fold. That adhesive is applied in a band parallel to and spaced from that creased fold.

The pairs of panels are then refolded along the associated creased folds into contiguous relation to adhesively bond adjacent panels together along a band spaced from the associated creased folds. The creased folds on the first side of the web are then removed from the web to form a plurality of aligned cells bounded by the remaining creased folds and the bands of adhesive applied on the first side of the web. The plurality of aligned cells are connected to one another by bands of adhesive applied on the second side of the web.

In a still further method, an expandable and collapsible product is produced by coating portions of both faces of a continuously fed web with an adhesive bonding substance in a predetermined bonding pattern. The bonding pattern comprises a plurality of narrow parallel stripes extending transversely the length of the web. The web is then transversely creased at predetermined locations relative to the bonding pattern to establish a pleat pattern on the web. The creases extend parallel to the adhesive bonding stripes.

The coated and creased web is then folded along the transverse creases and upon itself in alternating opposite directions. A stack of alternatingly directed pleats is accumulated to form an array of tubular cells. Each cell extends transversely the length of the web, with adjacent cells being joined together by the adhesive bonding stripes. Finally, one of the creases is removed from the web. This opens a first series of tubular cells, while a second series of tubular cells remains connected to one another by the adhesive bonding stripes.

In yet a further method, an expandable and collapsible product is produced by coating portions of both faces of a continuously fed web with an adhesive bonding substance in a predetermined bonding pattern. The bonding pattern comprises a plurality of narrow parallel stripes extending transversely the length of the web. The web is then transversely creased at predetermined locations relative to the bonding pattern to establish a pleat pattern on the web. The creases extend parallel to the adhesive bonding stripes and establish, upon subsequent folding of the web at the creases, a desired registration of adhesive stripes.

The coated and creased web is then folded along the transverse creases and upon itself in alternating opposite directions to thereby bring selected pairs of adhesive bonding stripes into face-to-face contact.

A stack of alternatingly directed pleats is accumulated to form an array of tubular cells each extending transversely the length of the web. Adjacent cells are joined together at selected pairs of adhesive bonding stripes. Certain of the creases are removed from the web, opening a first series of tubular cells, while a second series of tubular cells remain connected to one another by selected pairs of adhesive bonding stripes.

In another aspect of the invention, an expandable and collapsible product for window coverings and the like is provided. The product comprises a plurality of strips of material having first and second longitudinal edges. Each strip of material has a creased fold extending parallel to the longitudinal edges, dividing the strip of material into first and second panels having opposed faces. A tab is formed by joining the opposed faces together along the longitudinal edges. Each strip of material then defines an elongated cell having the creased fold projecting toward a second side of the cell and the tab projecting toward a first side of the cell. A bond line joins the first panel of each cell to the second panel of the next adjacent cell intermediate the creased folds and the tabs.

The tabs may have a width between about 0.030 inches and about 0.250 inches. The bond lines may comprise at least two parallel strips of adhesive spaced apart by a predetermined distance.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1A is a highly schematic end view of a partially expanded pleated material for forming the window covering of the invention;

FIG. 1B is a highly schematic end view of the pleated material of FIG. 1A after adhesive has been applied;

FIG. 1C is a highly schematic end view of the pleated material of FIG. 1A after bonding;

FIG. 1D is a highly schematic end view of the bonded pleated material of FIG. 1C after the first creases have been removed to form a single cell body;

FIG. 1E is a highly schematic end view of the single cell body of FIG. 1D after drilling;

FIG. 2 is a highly schematic perspective view of a fixture used in the step of removing the first creases in the method of the invention;

FIG. 3 is a cut-away perspective view of the expandable and collapsible window covering of the invention;

FIG. 4 is an enlarged partial perspective view of a tab in accordance with one embodiment of the window covering of the invention; and

FIG. 5 is an enlarged diagrammatic end view showing the positions of the bond lines relative to the creases.

### DETAILED DESCRIPTION

The present invention relates to a pleated single-cell product for window coverings and the like, and a method of making such a product from a single web of foldable material. The method is an improvement over the method disclosed in U.S. Pat. No. 5,160,563, to Kutchmarek et al., the disclosure of which is hereby incorporated by reference herein. That patent discloses a process for manufacturing a double cell or a multi-cell product for window coverings; i.e., a product having cells partially or completely displaced horizontally from one another. The present invention is addressed to a single-cell product; i.e., a product in which all cells are aligned vertically.

To manufacture an expandable and collapsible product that may be used as a window covering according to one method of the present invention, a continuous web of material 100 is first provided. The width of the continuous material may be the width of a single window covering, or may be large enough to cut several window coverings side-by-side from a single web. In a preferred embodiment, a nominal web width of eight feet or ten feet is used. Non-woven polyester fabric is the preferred material; however, any fabric, film or other web material that can be permanently creased may be used. The web may, for example, be formed of suitable plastic film such as polyester film, or from woven or non-woven material formed from various fibers, including natural and synthetic, such as polyester that retains a crease when folded in the presence of heat.

Where desired, web 100 may be printed or dyed in order to impart a color, a design or both to the finished window covering. In such an embodiment, stripes 101 running the width of the web, may be printed on one side of the web using a rotogravure printing process applying solvent or water-based pigments. Other printing processes, such as screen printing, may also be used. Alternatively, fabric webs may be dyed through their entire thickness using a solvent or water-based dye.

Stripes 101, shown schematically in cross-section in FIG. 5, are located and sized so that the side 22 of the completed window covering appears uniformly shaded in the color of the stripes. As will be appreciated from the discussion of the forming method hereinbelow, the unprinted regions between the stripes will appear in the interior of the cells 11 and on the other side 29 of the window covering. In an embodiment comprising 1½ inch nominal pleats as shown diagrammatically in FIG. 5, the width of the stripes is 1 7/16 inches and the stripes are spaced apart 1 9/16 inches.

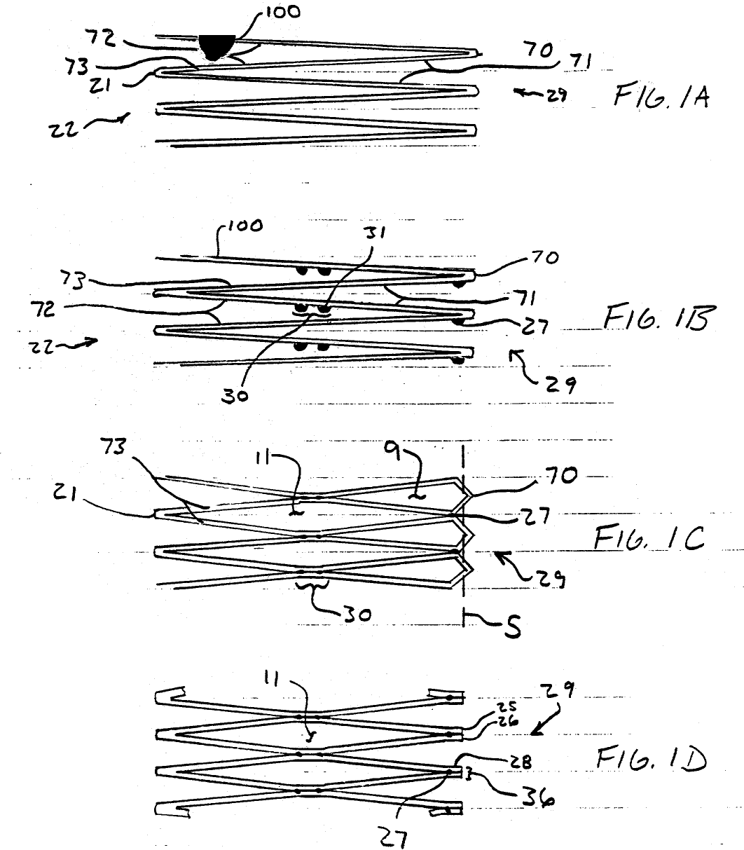

The continuous web of material 100 is next pleated widthwise as shown in FIG. 1A, in a direction parallel to stripes 101. Where material 100 is a non-woven polyester fabric, the fabric may be creased at about 175 to 200 degrees F., as is known in the art. The pleats may be compressed together and allowed to cool for about one-half hour to ambient temperature. Individual panels 73 are formed in this step, and are bounded by a first crease 70 projecting toward the side 29 of the pleated fabric, and a second crease 21 projecting toward the side 22 of the pleated fabric. Each panel has a first face 71 generally facing toward the side 29 of the material and a second face 72 generally facing toward the side 22 of the material.

Preferably, the creases are located such that the second creases 21 fall at the midpoints of the stripes 101 and the first creases 70 fall at the midpoints of the unprinted regions between the stripes, all as illustrated in FIG. 5.

Adhesive beads forming bonding lines 27, 30 are next applied transversely to the continuous web of material 100 as shown in FIG. 1B. The adhesive is preferably applied in a thin bead along the length of the web using shuttle-mounted adhesive applicators as is known in the art and as disclosed in U.S. Pat. No. 5,160,563 to Kutchmarek et al. The preferred adhesive is a moisture cured polyurethane, although other adhesives such as thermoplastics, including polyamides and polyesters, thermoset plastics or cold bonding adhesives may be used. Alternatively, other bonding methods such as ultrasonic welding or laser welding may be used.

Alternatively, a contact-type adhesive may be applied to both adjacent faces 72 at opposing locations within the pleats.

In a preferred embodiment, moisture cured polyurethane is applied at 275 degrees F to form a bead 1/32 inches or less in cross-sectional diameter running parallel with the creases 21, 70. To apply the adhesive, two adjacent panels 73 are partially spread or unfolded from the side 22, exposing the faces 72. The adhesive may be applied to every other face 72 along a line C at a spaced distance from crease 70 to form bonding line 30. Bonding line 30 may consist of a single bead of adhesive. Preferably, however, bonding line 30 comprises two separate beads of adhesive 31a and 31b spaced apart a distance W₂ symmetrically about line C. The distance W₂ between adhesive beads 31a and 31b is preferably between about 1/32 inches and about ¼ inches, and most preferably about 3/16 of an inch.

The panels 73 are next spread or unfolded from the side 29, exposing the faces 71, shown in FIG. 1B. The adhesive may be applied to every other face 71 to form a bonding line 27 between crease 70 and bonding line 30. Alternatively, a contact adhesive may be applied to both adjacent faces 71 at opposing locations.

In the preferred embodiment shown schematically in FIG. 5, having a nominal panel width W of 1½ inches, line C may be located a nominal distance D₁ of 25/32 inches from crease 70. Bonding line 27 may be located a nominal distance D₂ of 1/16 inches from crease 70. Printed stripe 101 would extend from line C on one panel 73 across crease 21 to an equivalent point on the next adjacent panel 73.

Before the adhesive sets, each panel 73 to which adhesive has been applied is compressed against the previous adjacent panel. The panels are compressed alternately from side 22 and side 29 as the adhesive is applied from the opposite side. For example, referring to FIG. 1B, after bonding line 27 has been applied to a face 71, a compression blade (not shown) entering the stack from side 22 compresses that panel against the previously compressed panels. That motion exposes faces 72 on side 22 for the application of adhesive forming bonding line 30. The process is continued until a length of window covering suitable for cutting to size is formed. Typically, a fourteen inch high stack of compressed pleats forms approximately thirty to forty-five feet of window covering.

As a result of compressing the panels 73 together, the bonding lines 30, 27, which had been beads of adhesive, are flattened and widened as they contact adjoining panels 73. Thus, for example, a 1/32 inch bead of adhesive may form a bonding line ⅛ inches or more in width after the panels are compressed.

The pleated material after bonding is shown expanded in a schematic end view in FIG. 1c. At this point, the process has produced two rows of partially overlapping cells, but that structure differs from the structure of U.S. Pat. No. 5,160,563 to Kutchmarek et al in that the two rows of cells in this case have different sizes and shapes. Cells 11 in a first row are each enclosed by two panels 73 of the material and bounded at one end by a crease 21 and at the other end by a bonding line 27. Each cell 9 in the other row is also enclosed by two panels 73 and is bounded by the a bonding line 30 and a crease 70.

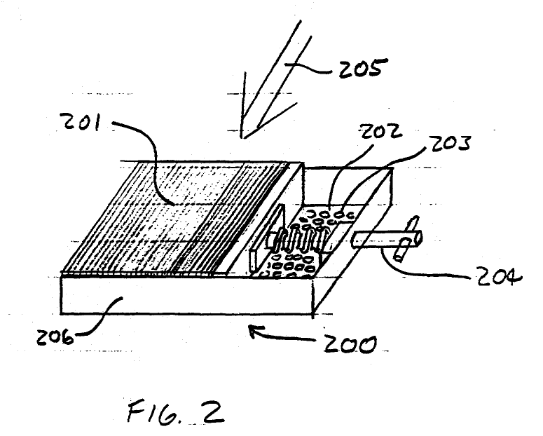

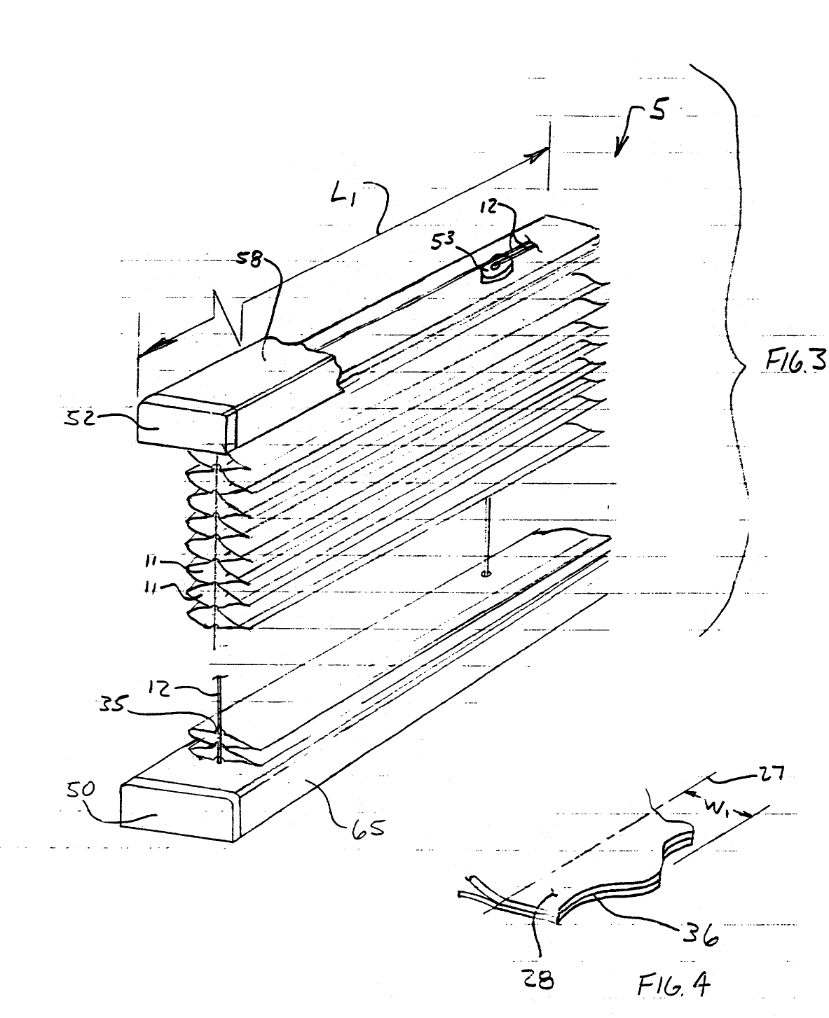

The material forming creases 70 is next removed to form the single cell configuration of the final expandable and collapsible product, as shown partially expanded in FIG. 1D. In a preferred removal step, crease 70 is sanded from the pleated material while the material is compressed as described above. A fixture 200, shown in FIG. 2, may be used to tightly compress the stack of pleated material 201 as the material is fed through a sanding machine. The fixture 200 has a compression means 204, such as a spring-loaded plunger or hand screw, to maintain a compressive force on the pleated stack 201 during sanding. The bottom 202 of the fixture has perforations 203 to permit a vacuum to be applied through the bottom 202 in order to hold the pleated stack 201 in place. The sides 206 of the fixture are shorter in height than the width of the stack 201 in order to permit the removal of material by the sander.

In the currently preferred embodiment, a Model 137-2 HPK/A Knife Planner/Sander sold by Timesavers, Inc. of Minneapolis, Minn., U.S.A. removes creases 70 from the pleated material. The fixture 200 preferably is fed into the sanding machine on a perforated feed belt having vacuum drawn through the perforations to retain the material in the fixture. The fixture 200 preferably is fed into the machine in a direction parallel to the pleats, represented by arrow 205 in FIG. 2, with the sanding belts extending perpendicular to the pleats across the entire stack in order to minimize disturbance of the stack by the sanding forces generated. The sanding operation preferably is performed in two stages within the sanding machine. First, an 80-grit belt removes between 0.040 and 0.045 inches from the side 29 of the completed stack. Creases 70 is removed during this first sanding step. A second sanding step using a 100-grit belt removes an additional 0.005 inches. The second sanding step also removes frayed ends of fibers left by the initial sanding step.

Other material removal processes may also be used to remove creases 70. For example, the compressed, pleated stack may be planed, knife-sliced, milled or laser cut. Alternatively, the individual cells 9 may be opened by slitting each crease 70 using a knife, a laser or other means.

A line S defining the sanding depth is shown schematically in FIG. 1C. The line is located between creases 70, which are removed in the sanding operation, and bonding lines 27, which remain intact. The sanding operation exposes co-extensive longitudinal edges 25, 26, shown in FIG. 1D. The longitudinal edges, in turn, form a free edge 36. The material between edge 36 and bonding line 27 forms a tab 28 protruding from the side 29 of each cell 11.

As an alternative to sanding the free edges 36 flat, a profile may be formed by varying the depth to which the tabs 28 are machined. For example, a repeating, uniform profile, such as a sinusoidal pattern shown in FIG. 4, may be formed on the tabs during the material removal step described above. Alternatively, such profile may be formed subsequent to the above-described material removal step by using a sanding disk, a grinding wheel, a laser or other material removal means. In addition to repeating uniform profiles, other patterns or indicia may be formed in the tabs, including patterns that will display a mural or other art work when the window covering is in the expanded condition. So that they remain self-supporting in their free state, the tabs preferably have a width between bonding lines 27 and the free edges 36 of between about 1/32 inches and ¼ inches.

Where heavier materials are used or where the pleats are wide, individual pleats of the window covering may tend to sag toward the bottom. Restraints fabricated from cord may be used in the art to maintain the pleats at an even pitch over the length of the window covering. Holes (not shown) may be drilled in the tabs 28 in order to accommodate knotted cord or a laddered cord to perform this function.

After the creases 70 have been removed, the exposed free edges 36 may be colored by spraying, rolling or otherwise applying a dye, paint, pigment or other coloring. This may be done, for example, where panel faces 71 have been colored, in order to provide a color on the free edges 36 that matches, accents or coordinates with the panel color.

After completion of the crease removal step, an expandable and collapsible product according to the invention has been formed. That product may be used in the manufacture of a window covering according to the invention as described hereinbelow. The steps comprising the method of producing the expandable and collapsible product may be altered in order. For example, the step of applying the adhesive may precede the step of creasing the web of material, as disclosed in U.S. Pat. No. 5,106,444 to Corey et al. which is hereby incorporated by reference in its entirety herein.

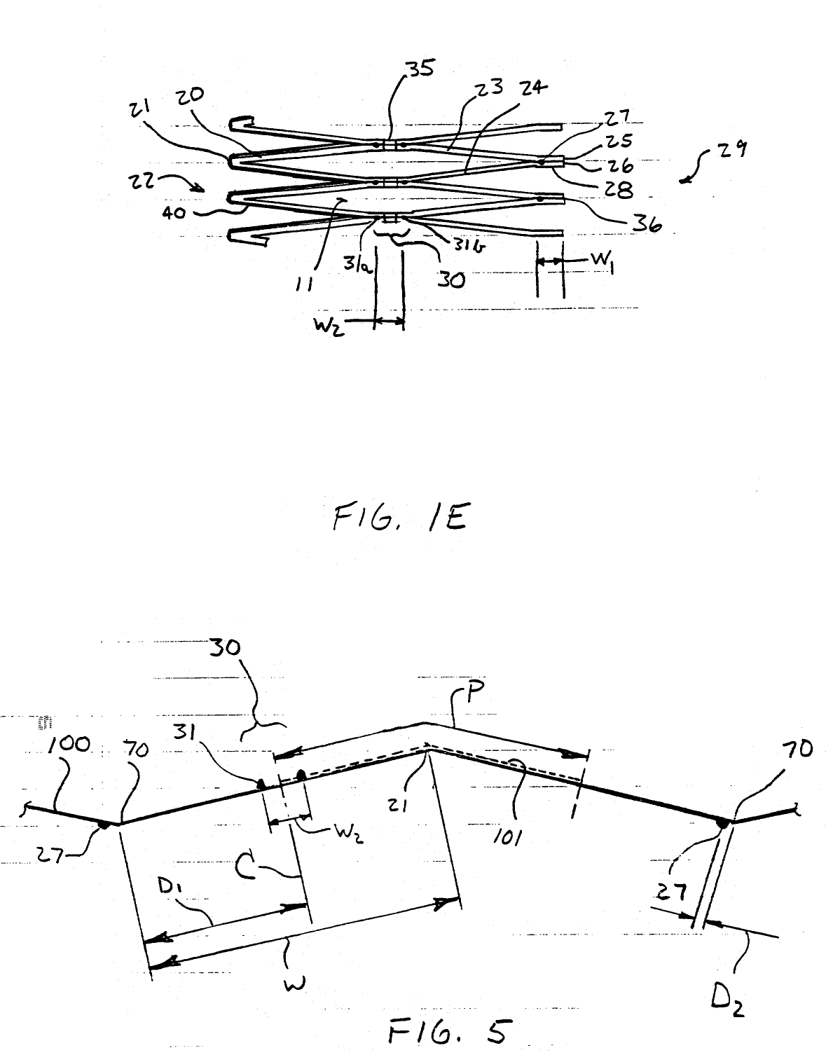

Holes 35, shown in FIG. 1E, may be formed in the expandable and collapsible product in order to use it in a pleated window covering. The holes are preferably centered on the width of the pleat, and are used for routing one or more of the braided cords 12 (FIG. 3) through the window covering. The holes preferably are drilled, but alternatively may be punched, laser cut or otherwise formed. The holes are formed while the pleated window covering is in the compressed state. The holes 35 are preferably ⅛ inches in diameter to provide sufficient clearance for braided cords 12 to move smoothly therethrough without binding or catching.

In the embodiment in which two connecting lines 31a and 31b comprise the bonding line 30, the hole 35 is drilled between the connecting lines as shown in FIG. 1E. Alternatively, where the first bonding line 30 is a single line of adhesive, the hole 35 may be drilled through the bonding line. It is preferred to drill between the connecting lines 31a, 31b, as opposed to drilling through a single bonding line, because the relative hardness of the adhesive slows the drilling operation and requires a greater drilling force. Further, adhesive that has been drilled tends to adhere to the drilling tool, interfering with the drilling operation.

The window covering is next cut to size. The cutting operation may be performed before or after drilling. In the embodiment in which the width of the window covering as manufactured exceeds the width of the finished products, the individual window coverings are cut to width using a saw, guillotine, hot wire, laser or other cutting means. In addition, the window coverings are cut to length in order to accommodate the individual window length. This may be done by using a saw, laser or hot wire, by shearing along a bond line 30 or by other means. Alternatively, the adhesive applicator for the bond line 30 may be programmed to skip one panel at a predetermined count of panels equaling the number of panels in a single window covering.

A braided cord 12 is routed through the holes 35 in each of the cells 11. Near the top of the window covering 5, the braided cord is routed through a pulley and retainer system (not shown) as is conventional in the art to enable an operator to expand and collapse the window covering. Grommets such as grommet 53 may be installed to provide a wear surface for the cord 12. A headrail 58 and bottom rail 65 are attached to the top and bottom cells, respectively, as is known in the art. End caps 52, 50 may be force fit into the headrail 58 and bottom rail 65, respectively.

A completed expandable and collapsible window covering 5 according to the invention is shown in FIG. 3. The product comprises a series of cells 11 arranged vertically on one or more braided cords 12. Each of the cells 11 is aligned with the adjacent cells above and below.

As shown schematically in FIG. 1E, each cell 11 comprises a single strip of material 20 having a single creased fold 21 on a side 22 of the window covering. The creased fold 21 separates the strip of material into an upper panel 23 and a lower panel 24. Each strip of material 20 has first and second longitudinal edges 25, 26. A bonding line 27 S is formed by an adhesive that bonds the upper and lower panels 23, 24 near the longitudinal edges 25, 26. The portions of the panels 23, 24 between the bonding line 27 and the longitudinal edges 25, 26 form a tab 28 having a width W₁ which preferably is between about 1/32 inches and ¼ inches, and most preferably less than about 1/16 inches wide.

Each cell 11 is joined to an adjacent cell at a bond line 30. The width W₂ of the bond line 30 preferably is between about 1/32 inches and ¼ inches. In a currently preferred embodiment, the bond line 30 comprises two parallel connecting lines 31a, 31b formed of adhesive and spaced apart a predetermined distance. A cord hole 35 passes through each cell at or near the bonding lines 30. Where two connecting lines 31a, 31b comprise the bonding line 30, it is preferred that the cord hole 35 passes midway between the connecting lines, as shown in FIG. 1E.

The first and second longitudinal edges 25, 26 form a free edge 36 at the end of each tab 28. The expandable and collapsible window covering shown in FIG. 1E has uniform free edges 36 aligned with free edges of adjacent cells 11. The tab width W₁ is uniform throughout the length L₁, as shown in FIG. 3. Alternatively, the free edge 36 may depict a design or indicia by varying the width W₁. For example, as shown in FIG. 4, the free edge 36 may be scalloped. The scallops may be aligned from cell to cell in order to depict vertical bands on the side 29 of the expandable and collapsible window covering. Alternatively, horizontal stripes, diagonal stripes, patterns or even pictures or murals may be depicted in a similar manner.

A pigment or dye 40, shown schematically in FIG. 1E, may be applied to all or part of the side 22 of the expandable and collapsible window covering. The pigment or dye may be used to impart a solid color, a pattern or indicia on the window covering as described above.

The braided cord 12, shown in FIG. 3, passes through the holes 35 in cells 11. The headrail 58 is connected to the uppermost of the cells 11. The headrail improves the appearance of the window covering 5, and provides a mounting surface to mount the window covering to the window. The bottom rail 65 is connected to the lowermost of the cells 11. The grommets, such as grommet 53, provide a wear surface for the braided cord 12.

The braided cord 12 passes through each of the holes 35 (FIG. 1E) in each of the cells, maintaining the cells in alignment. The braided cord 12 may be extended and retracted in order to extend and collapse the window covering as is known in the art.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as set forth in the appended claims.

We claim:

1. A method of producing an expandable and collapsible product, comprising the steps of:
pleating a continuous length of material to form a plurality of first creases projecting toward a first side of said material and a plurality of second creases projecting toward a second side of said material, said first and second creases being interconnected by panels, each of said panels having a first face facing generally toward said first side and a second face facing generally toward said second side;
bonding opposed ones of said second faces together along first bond lines at a spaced distance from said first creases to form a first series of enclosed cells bounded by said first creases and said first bond lines;
bonding opposed ones of said first faces together along second bond lines between said first creases and said first bond lines to form a second series of enclosed cells bounded by said second creases and said second bond lines; and
removing said first creases from said material, whereby said first series of enclosed cells are opened and said second series of enclosed cells remain connected to one another by said first bond lines.

2. The method as claimed in claim 1, wherein said removing step includes the step of abrading said material along said first creases.

3. The method as claimed in claim 2, wherein said abrading step includes the steps of initially abrading said material using relatively coarse media to remove said first creases, said initial abrading step creating coarse edges, and then abrading said material using relatively fine media to smooth out said coarse edges.

4. The method as claimed in claim 1, wherein said removing step includes the step of cutting said material adjacent said first creases.

5. The method as claimed in claim 1, wherein a distance between said first creases and said second bond lines is less than a distance between said second creases and said first bond lines.

6. The method as claimed in claim 5, wherein said distance between said first creases and said second bond lines is at least about 1/32 inches.

7. The method as claimed in claim 5, wherein said distance between said first creases and said second bond lines is about 1/16 inches.

8. The method as claimed in claim 1, wherein said first bond lines are about equidistant between said second creases and said second bond lines.

9. The method as claimed in claim 1, wherein each of said first bond lines includes at least two parallel connecting lines separated by a predetermined distance.

10. The method as claimed in claim 9, wherein said at least two connecting lines are centered about a line about equidistant between said second creases and said second bond lines.

11. The method as claimed in claim 9, wherein said predetermined distance is between about 1/32 inches and about ¼ inches.

12. The method as claimed in claim 9, further comprising the step of placing at least one hole in each of said panels between said at least two connecting lines.

13. The method as claimed in claim 1, wherein said first bond lines have a width of between about 1/32 inches and about ¼ inches.

14. The method as claimed in claim 1, wherein each of said panels has a width between said first and second creases, said pleating step being conducted so that said widths of said panels are about equal.

15. The method as claimed in claim 1, wherein said step of bonding said opposed ones of said second faces together includes the steps of applying a strip of an adhesive to at least one of said opposed second faces in a direction parallel to said second creases at said spaced distance from said first creases, and pressing said opposed second faces together.

16. The method as claimed in claim 1, wherein said bonding steps include the steps of applying a strip of an adhesive to at least one of said opposed faces along said bond lines.

17. The method as claimed in claim 16, wherein said adhesive is selected from the group consisting of polyurethane adhesives, thermoplastic adhesives, thermosetting adhesives, cold bonding adhesives, and combinations thereof.

18. The method as claimed in claim 17, wherein said adhesive comprises a moisture cured polyurethane adhesive.

19. The method as claimed in claim 1, further comprising the step of placing at least one hole in each of said panels at a point about equidistant between said second creases and said second bond lines, whereby said hole in each one of said panels is aligned with the holes in the other ones of said panels.

20. The method as claimed in claim 1, further comprising the steps of applying indicia to said second faces of said panels in regions extending from said second creases to said first bond lines.

21. The method as claimed in claim 1, wherein said step of removing said first creases creates a tab on each one of said second series of enclosed cells, said tabs having an inner edge defined by said second bond line and a free edge.

22. The method as claimed in claim 21, further comprising the step of removing portions of said free edges of said tabs to create predetermined patterns in said tabs.

23. A method of producing an expandable and collapsible product, comprising the steps of:
providing a web of material accordion folded widthwise and having a series of panels united in alternate succession along first and second creased folds disposed at respective first and second sides of said web;
unfolding said panels;
applying adhesive to each panel in a band parallel to and spaced from the associated creased fold with a preceding panel;
refolding said panels having adhesive applied thereto along the associated creased fold with a preceding panel, said band of adhesive being applied on said second side of said web to each panel that is joined along a first creased fold to a preceding panel and said band of adhesive being applied on said first side of said web to each panel that is joined along a second creased fold to a preceding panel; and
removing said first creased folds from said web to form a plurality of aligned cells bounded by said second creased folds and said bands of adhesive applied on said first side of said web, said plurality of aligned cells being connected to one another by said bands of adhesive applied on said second side of said web.

24. A method of producing an expandable and collapsible product, comprising the steps of:
folding a web of material widthwise alternately in opposite directions along first and second creased folds respectively disposed at first and second sides of said web to form a series of normally flat panels of uniform width and united in alternate succession along respective ones of said first and second creased folds;
unfolding said panels;
applying adhesive on said second side of said web to one of each pair of panels that are united along a first creased fold in a band parallel to and spaced from said first creased fold;
applying adhesive on said first side of said web to one of each pair of panels that are united along a second creased fold in a band parallel to and spaced from said second creased fold;
refolding said pairs of panels along the associated creased folds into contiguous relation to adhesively bond adjacent panels together along a band spaced from the associated creased folds; and
removing said first creased folds from said web to form a plurality of aligned cells bounded by said second creased folds and said bands of adhesive applied on said first side of said web, said plurality of aligned cells being connected to one another by said bands of adhesive applied on said second side of said web.

25. A method of producing an expandable and collapsible product comprising the steps of:
coating portions of both faces of a continuously fed web with an adhesive bonding substance in a predetermined bonding pattern, said bonding pattern comprising a plurality of narrow parallel stripes extending transversely to the length of said web;
transversely creasing said web at predetermined locations relative to said bonding pattern to establish a pleat pattern on said web, said creases extending parallel to said adhesive bonding stripes;
folding said coated and creased web along said transverse creases and upon itself in alternating opposite directions;
accumulating a stack of alternatingly directed pleats to form an array of tubular cells each extending transversely to the length of said web, with adjacent cells being joined together by said adhesive bonding stripes;
removing ones of said creases from said web, whereby a first series of said tubular cells are opened and a second series of said tubular cells remain connected to one another by ones of said adhesive bonding stripes.

26. A method of producing an expandable and collapsible product, comprising the steps of:
coating portions of both faces of a continuously fed web with an adhesive bonding substance in a predetermined bonding pattern, said bonding pattern comprising a plurality of narrow parallel stripes extending transversely to the length of said web;
transversely creasing said web at predetermined locations relative to said bonding pattern to establish a pleat pattern on said web, said creases extending parallel to said adhesive bonding stripes and establishing, upon subsequent folding of said web at said creases, a desired registration of adhesive stripes;
folding said coated and creased web along said transverse creases and upon itself in alternating opposite directions to thereby bring selected pairs of said adhesive bonding stripes into face-to-face contact;
accumulating a stack of alternatingly directed pleats to form an array of tubular cells each extending transversely to the length of said web, with adjacent cells being joined together at selected pairs of said adhesive bonding stripes; and
removing ones of said creases from said web, whereby a first series of said tubular cells are opened and a second series of said tubular cells remain connected to one another by ones of said selected pairs of said adhesive bonding stripes.

27. An expandable and collapsible product, comprising
a plurality of strips of material, each strip of material having a first longitudinal edge and a second longitudinal edge;
a creased fold in each strip of material extending parallel to said longitudinal edges, said creased fold dividing said strip of material into first and second panels having opposed faces;
a tab formed by joining said opposed faces together along said longitudinal edges, whereby each one of said strips of material defines an elongated cell having said creased fold projecting toward a second side of said cell and said tab projecting toward a first side of said cell; and
a bond line joining said first panel of each cell to said second panel of the next adjacent cell intermediate said creased folds and said tabs.

28. The expandable and collapsible product as claimed in claim 27, wherein said tabs have a width between about 1/32 inches and about ¼ inches.

29. The expandable and collapsible product as claimed in claim 27, wherein said bond lines comprise at least two parallel strips of adhesive spaced apart by a predetermined distance.

30. The expandable and collapsible product as claimed in claim 29, wherein said spaced distance is between about 1/32 inches and about ¼ inches.

31. The expandable and collapsible product as claimed in claim 29, wherein said adhesive is selected from the group consisting of polyurethane adhesives, thermoplastic adhesives, thermosetting adhesives, cold bonding adhesives, and combinations thereof.

32. The expandable and collapsible product as claimed in claim 27, wherein said tabs are shaped with predetermined patterns.

33. The expandable and collapsible product as claimed in claim 27, wherein faces of said first and second panels opposite said oppose faces include indicia extending from said creased folds to said bond lines.

34. A window covering, comprising
a multi-cellular expandable and collapsible body having a top end and a bottom end, said body including a plurality of strips of material, each strip of material having a first longitudinal edge and a second longitudinal edge, a creased fold in each strip of material extending parallel to said longitudinal edges, said creased fold dividing said strip of material into first and second panels having opposed faces, a tab formed by joining said opposed faces together along said longitudinal edges, whereby each one of said strips of material defines an elongated cell having said creased fold projecting toward a first side of said cell and said tab projecting toward a second side of said cell, and a bond line joining said first panel of each cell to said second panel of the next adjacent cell intermediate said creased folds and said tabs;
a head rail connected to said top end of said body;
a bottom rail connected to said bottom end of said body; and
means for raising and lowering said bottom rail relative to said head rail.
